(19) United States
(12) Patent Application Publication
(10) Pub. No.: US 2025/0132978 A1
(43) Pub. Date: Apr. 24, 2025

(54) MANAGEMENT SYSTEM, MANAGEMENT METHOD, AND MANAGEMENT PROGRAM

(71) Applicant: Nippon Telegraph and Telephone Corporation, Tokyo (JP)

(72) Inventors: Hiroki INOUE, Musashino-shi, Tokyo (JP); Yasuyuki NIIHARA, Musashino-shi, Tokyo (JP); Atsushi SUTO, Musashino-shi, Tokyo (JP); Shinji ABE, Musashino-shi, Tokyo (JP); Hiroki HOSONO, Musashino-shi, Tokyo (JP)

(21) Appl. No.: 18/834,242

(22) PCT Filed: Feb. 17, 2022
(86) PCT No.: PCT/JP2022/006493

§ 371 Date: Jul. 30, 2024

(51) Int. Cl. H04L 41/084

(52) U.S. Cl. CPC H04L 41/0846

(57) ABSTRACT

A management system manages a migration from a migration source NW device to a migration destination NW device among NW devices communicating with another communication device on a network, the management system comprising a conversion unit that converts a system of configuration data for setting an operation of the migration source NW device into configuration data according to a system of configuration data of the migration destination NW device by using a general-purpose parameter table capable of associating each service in a user unit, and applies the configuration data to the migration destination NW device.

### TECHNICAL FIELD

The present invention relates to a management device, a management method, and a management program.

### BACKGROUND ART

With respect to a NW device constituting a network (NW), there is a case where data are migrated from the current NW device to a successor NW device due to device renewal or the like. In such a case, when the current NW device and the successor NW device have different configuration systems, it is necessary to convert the configuration data of the current NW device into the configuration data of the successor NW device. The configuration data is setting data for setting the operation of a NW device.

A data migration method for migrating data between different databases has conventionally been proposed (see PTL 1).

### CITATION LIST

### Patent Literature

[PTL 1] Japanese Patent No. 6059682

### SUMMARY OF INVENTION

### Technical Problem

FIG. 12 is a diagram for explaining configuration conversion processing that employs prior art. The configuration data of a NW device has a structure in which a plurality of pieces of associated setting information are arranged in a nested manner. However, as shown in the pre-conversion configuration data example and the post-conversion configuration data example in FIG. 12, the data structure of configuration data varies depending on the configuration system, such as the combination of the associated setting information and the nesting relationship. Therefore, unlike the database structure, simple one-to-one conversion for configuration data cannot be performed.

The method described in PTL 1 assumes a database structure in which headings and values are arranged in parallel, and the conversion logic is simple. Therefore, the method described in PTL 1 specialized in a database structure such as migration between different databases cannot be applied to migration of configuration data between NW devices having different configuration systems.

An object of the present invention is to provide a management system, a management method, and a management program that enable migration of configuration data between network devices of different configuration systems.

### Solution to Problem

In order to solve the above-mentioned problem and achieve the object, a management system according to the present invention is a management system for managing a migration from a migration source network device to a migration destination network device among network devices communicating with another communication device on a network, the management system comprising a conversion unit that converts a system of first setting data for setting an operation of the migration source network device into second setting data according to a system of setting data of the migration destination network device by using a general-purpose parameter table capable of associating each service in a user unit, and applies the second setting data to the migration destination network device.

### Advantageous Effects of Invention

According to the present invention, migration of configuration data between network devices of mutually different configuration systems is made possible.

### BRIEF DESCRIPTION OF DRAWINGS

FIG. 1 is a block diagram showing an example of a configuration of a management system according to an embodiment.

FIG. 2 is a block diagram showing an example of a configuration of a conversion device shown in FIG. 1.

FIG. 3 is a diagram showing an example of a data structure of a general-purpose parameter table.

FIG. 4 is a diagram for explaining processing performed by a conversion unit shown in FIG. 2.

FIG. 5 is a diagram for explaining processing performed by the conversion unit shown in FIG. 2.

FIG. 6 is a block diagram showing an example of a configuration of a confirmation device shown in FIG. 1.

FIG. 7 is a diagram for explaining processing of a confirmation unit shown in FIG. 6.

FIG. 8 is a sequence diagram showing an example of a processing procedure of management processing according to an embodiment.

FIG. 9 is a sequence diagram showing an example of a processing procedure of confirmation processing according to an embodiment.

FIG. 10 is a block diagram showing an example of a configuration of a migration source network (NW) device.

FIG. 11 is a diagram showing an example of a computer that implements the conversion device, the confirmation device, and the migration source NW device by executing a program.

FIG. 12 is a diagram for explaining configuration conversion processing that employs prior art.

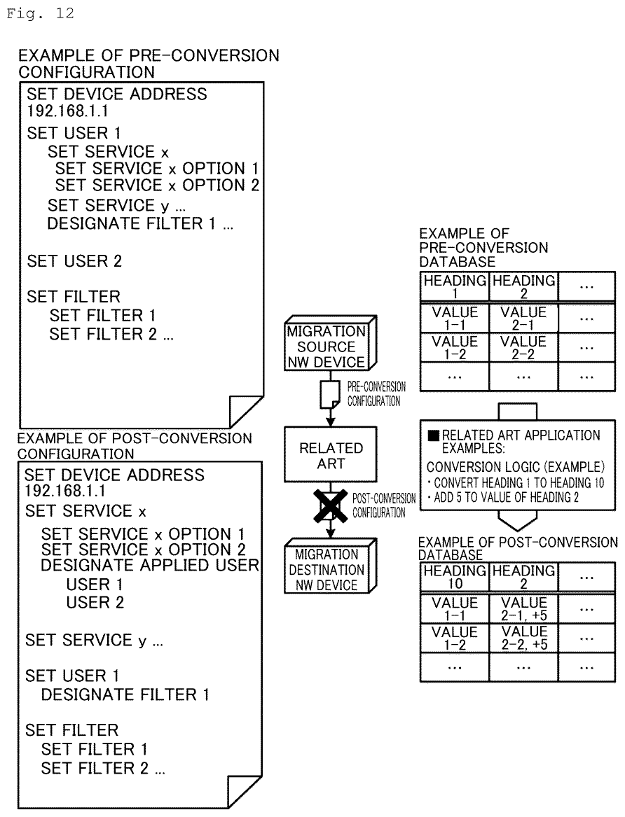

### DESCRIPTION OF EMBODIMENTS

Hereinafter, a management system, a management method, and a management program according to the present application will be described in detail with reference to the drawings. Note that the management system, management method, and management program according to the present application are not limited to this embodiment.

### Embodiment

First, an embodiment will be described. The embodiment describes a management system for managing the migration of a configuration from a migration source NW device to a migration destination NW device among network devices communicating with other communication devices on a network (NW).

The embodiment describes the case where the systems of configuration data vary between the migration source NW device and the migration destination NW device. The configuration data is setting data for setting the operation of a NW device, and has a structure in which a plurality of pieces of associated setting information (parameters) are arranged in a nested manner. A different configuration data system means that a combination of parameters to be linked and a relationship of nesting are different.

### Configuration of Communication System

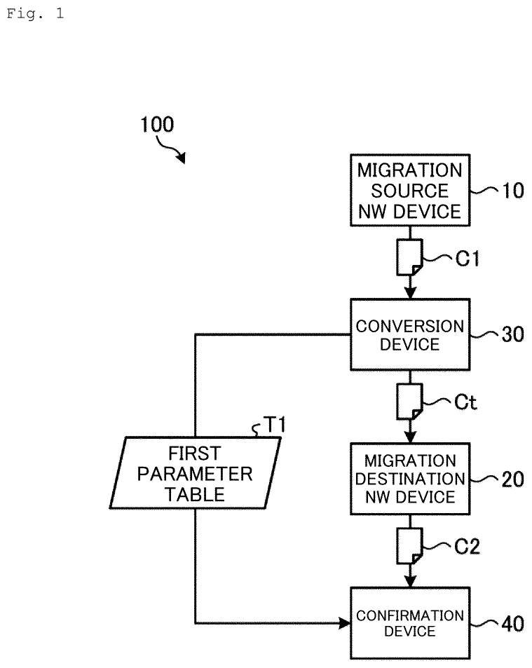

A configuration of the management system according to the embodiment is now described. FIG. 1 is a block diagram showing an example of the configuration of the management system according to the embodiment.

As shown in FIG. 1, a management system 100 according to the embodiment manages the migration of configuration data between a migration source NW device 10 and a migration destination NW device 20 among network devices communicating with other communication devices on the NW. The management system 100 includes a conversion device 30 and a confirmation device 40.

The conversion device 30 is provided between the migration source NW device 10 and the migration destination NW device 20. The conversion device 30 converts a system of configuration data C1 (first setting data) of the migration source NW device 10 into configuration data Ct (second setting data) according to a system of configuration data of the migration destination NW device 20 by using a general-purpose parameter table capable of associating each service in a user unit. The conversion device 30 applies the converted configuration data Ct to the migration destination NW device 20.

The confirmation device 40 confirms that the setting information is successfully taken over between the migration source NW device 10 and the migration destination NW device 20 having different configuration data systems. The confirmation device 40 inputs configuration data C2 (third setting data) applied to the migration destination NW device 20 and a first parameter table T1 (described later) created by the conversion device 30. The confirmation device 40 confirms that the configuration data C1 is successfully migrated to the migration destination NW device 20, on the basis of the configuration data C2 and the first parameter table T1.

### Conversion Device

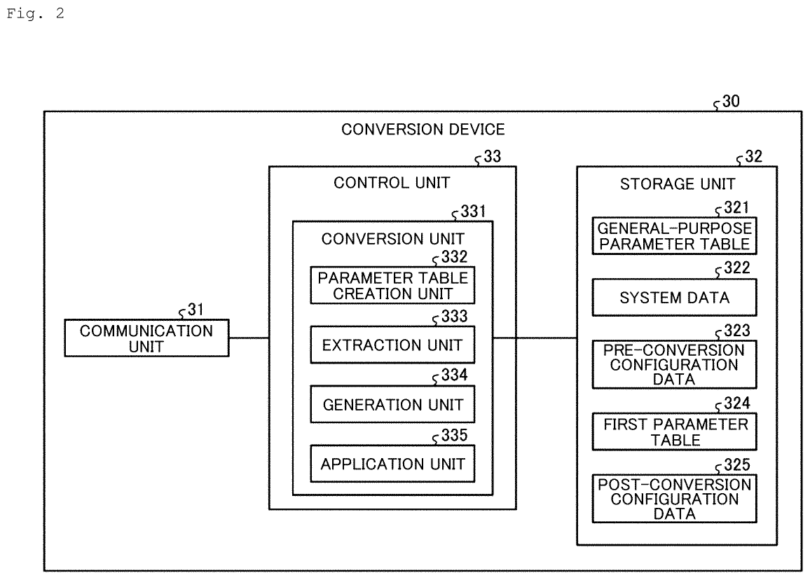

The conversion device 30 will be described next. FIG. 2 is a block diagram showing an example of the configuration of the conversion device 30 shown in FIG. 1. As shown in FIG. 2, the conversion device 30 includes a communication unit 31, a storage unit 32, and a control unit 33.

The communication unit 31 is a communication interface that transmits and receives various types of information to and from other devices connected via a network or the like. The communication unit 31 is realized by an NIC (Network Interface Card) or the like, and performs communication with other devices (e.g., the migration source NW device 10, the migration destination NW device 20, the confirmation device 40 and the control unit 33 (described later) via a telecommunication line such as a LAN (Local Area Network) or the Internet.

The storage unit 32 is, for example, a storage device such as an HDD (Hard Disk Drive) or an SSD (Solid State Drive). It should be noted that the storage unit 32 may be a semiconductor memory in which data is rewriteable, such as a RAM (Random Access Memory), a flash memory, or an NVSRAM (Non Volatile Static Random Access Memory). The storage unit 32 stores an OS (Operating System) and various programs to be executed by the conversion device 30. Further, the storage unit 32 stores various types of information used in executing the programs. The storage unit 32 stores a general-purpose parameter table 321, system data 322, pre-conversion configuration data 323, a first parameter table 324, and post-conversion configuration data 325.

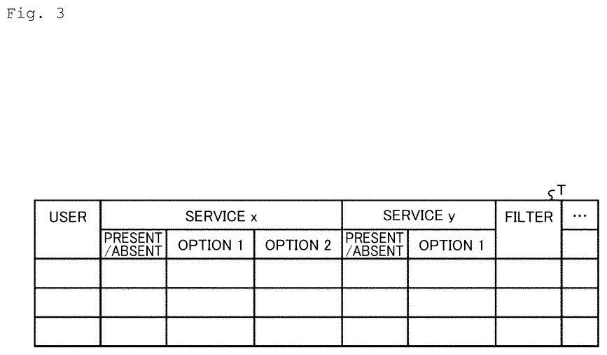

Also, the general-purpose parameter table 321 is a general-purpose parameter table created by a parameter table creation unit 332. FIG. 3 is a diagram showing an example of a data structure of the general-purpose parameter table. In the general-purpose parameter table 321, as shown in a general-purpose parameter table T in FIG. 3, the items of respective services are associated with the user. The items of the services are classified into the presence/absence of a service and each option. In the general-purpose parameter table 321, each item and its arrangement are set so that each service and an option of each service can be made to correspond to each other in a user unit.

The system data 322 is data indicating a system of configuration data of each NW device. Specifically, the system data 322 includes a format of configuration data of each NW device, e.g., a combination of parameters to be associated, the configuration of the nested relation of the combination.

The pre-conversion configuration data 323 is, for example, configuration data (e.g., the configuration data C1) of the migration source NW device 10. The first parameter table 324 is a first parameter table (e.g., the first parameter table T1) created by a generation unit 334 (described later). The pre-conversion configuration data 325 is, for example, configuration data (e.g., configuration data Ct) which is generated by the generation unit 334 (described later) and applied to the migration destination NW device 20.

The control unit 33 controls the entire conversion device 30. The control unit 33 is, for example, an electronic circuit such as a central processing unit (CPU) or a micro processing unit (MPU) or an integrated circuit such as an application specific integrated Circuit (ASIC) or a field programmable gate array (FPGA). The control unit 33 also has an internal memory for storing programs defining various processing procedures and control data, and executes each processing using the internal memory. Further, the control unit 33 functions as various processing units by operating various programs. The control unit 33 has a conversion unit 331.

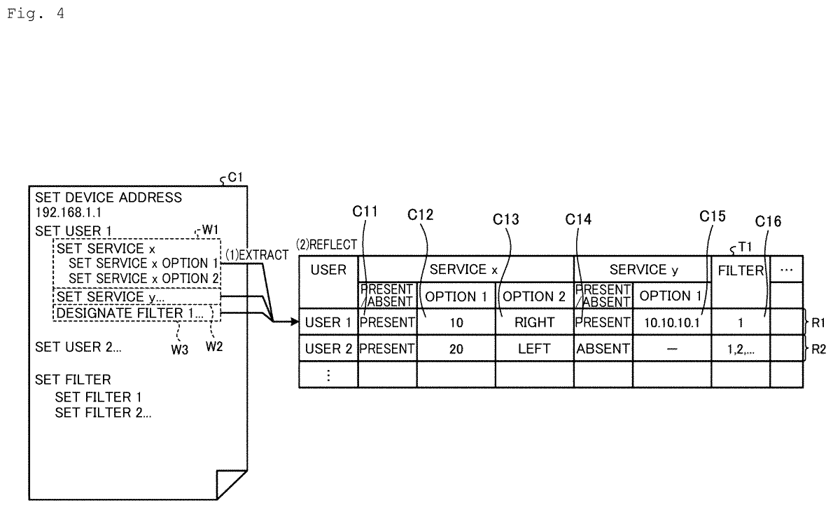

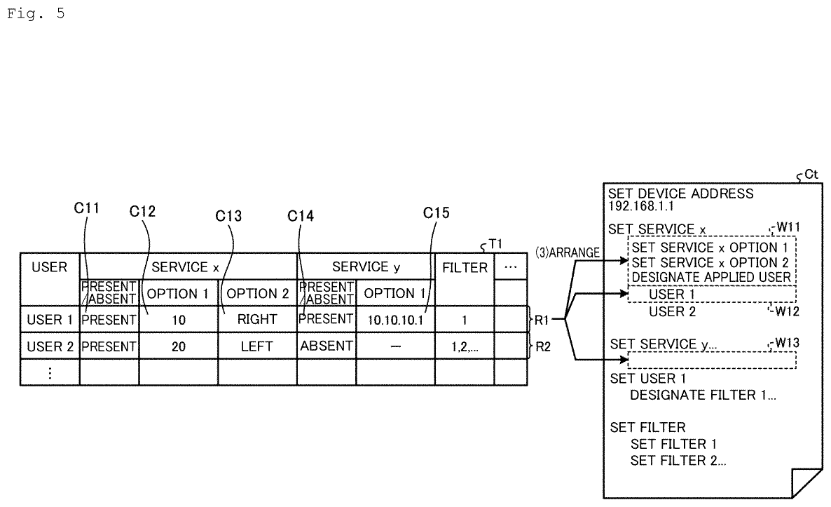

The conversion unit 331 converts the system of the configuration data C1 of the migration source NW device 10 into the configuration data Ct according to the system of the configuration data of the migration destination NW device 20, by using the general-purpose parameter table. The conversion unit 331 applies the configuration data Ct to the migration destination NW device 20. The conversion unit 331 includes the parameter table creation unit 332, an extraction unit 333 (first extraction unit), the generation unit 334, and an application unit 335. FIG. 4 and FIG. 5 are diagrams for explaining processing of the conversion unit 331 shown in FIG. 2.

The parameter table creation unit 332 creates a general-purpose parameter table capable of associating each service in a user unit. The parameter table creation unit 332 creates, for example, the general-purpose parameter table T shown in FIG. 3. The parameter table creation unit 332 may create the general-purpose parameter table T in advance, in addition to creating the general-purpose parameter table T when the NW device is migrated.

The extraction unit 333 extracts each parameter from the configuration data C1, describes each extracted parameter in a corresponding cell of the general-purpose parameter table T, and creates the first parameter table T1 corresponding to the configuration data C1. For example, as shown in FIG. 4, the case is described in which the configuration data C1 has a nested relationship in which services and options are associated for each user.

In this case, for the user 1 of the configuration data C1, the extraction unit 333 extracts data “service x setting,” “service x option setting 1,” and “service x option setting 2” within an area W1 ((1) of FIG. 4). Then, the extraction unit 333 reflects the extracted contents by writing them in cells C11, C12, and C13 corresponding to a service x and options 1and 2 thereof in a row R1 of the first parameter table T1 (as shown in (2) of FIG. 4).

Then, the extraction unit 333 extracts a parameter related to a service y in an area W2 of the configuration data C1, and reflects the extracted data in cells C14 and C15 corresponding to items of the service y in the row R1 of the first parameter table T1. The extraction unit 333 extracts a parameter in an area W3 of the configuration data C1, and reflects the extracted parameter on a cell C16 corresponding to a filter item of the row R1 of the first parameter table T1. Similarly, for a user 2 as well, the extraction unit 333 extracts a parameter from the configuration data C1 and describes the extracted parameter in each corresponding cell of a row R2 of the general-purpose parameter table T.

In this manner, the extraction unit 333 extracts each associated parameter from the configuration data C1 for each user, and describes each parameter in each corresponding cell of the general-purpose parameter table T, thereby creating the first parameter table T1 reflecting the parameters of the configuration data C1. The extraction unit 333 outputs the created first parameter table T1 to the confirmation device 40.

The generation unit 334 generates the configuration data Ct in which parameters described in each cell of the first parameter table T1 are arranged according to a system of configuration data applied to the migration destination NW device 20. For example, as shown in the configuration data Ct in FIG. 5, a case will be described in which the configuration data system of the migration destination NW device 20 has a nested relationship in which the user and the option are associated with each other for each service.

In this case, the generation unit 334 arranges the contents described in the cells C11, C12, and C13 for a service x in the row R1 of the first parameter table T1, in a setting area W11 for the service x ((3) in FIG. 5), and arranges “user 1” in an area W12, to indicate that the parameters in the setting area W11 are tied to the user 1. Further, the generation unit 334 arranges the contents described in the cells C14 and C15 for a service y in the row R1 of the first parameter table T1, in a setting area W13 for the service y ((3) in FIG. 5). Similarly, the generation unit 334 generates the configuration data Ct by arranging the contents of each cell on and after the row R2 of the first parameter table T1, in a corresponding area.

The application unit 335 applies the configuration data Ct generated by the generation unit 334, to the migration destination NW device 20.

### Confirmation Device

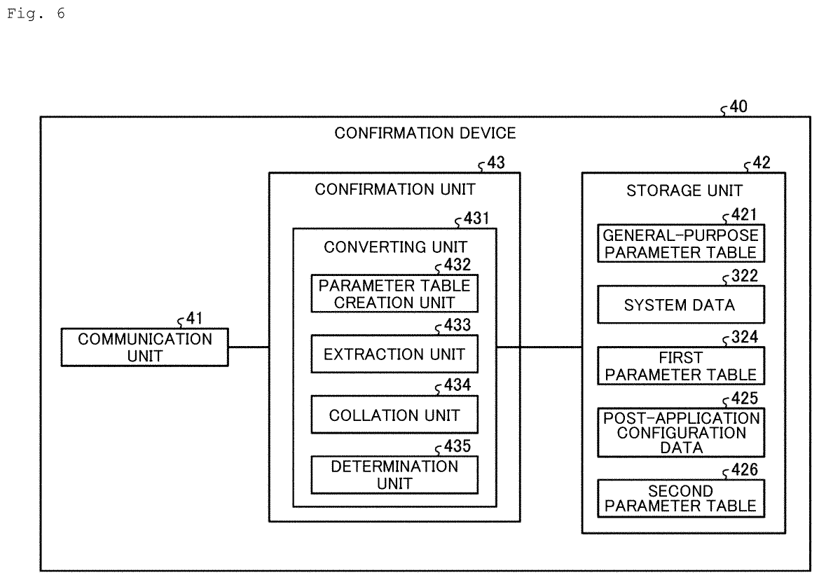

The confirmation device 40 will be described next. FIG. 6 is a block diagram showing an example of a configuration of the confirmation device 40 shown in FIG. 1. As shown in FIG. 6, the confirmation device 40 includes a communication unit 41, a storage unit 42, and a control unit 43.

The communication unit 41 is a communication interface that transmits and receives various types of information from other devices connected via a network. The communication unit 41 is realized by a NIC or the like and performs communication between other devices (e.g., the migration destination NW device 20, the conversion device 30) and the control unit 43 (described later) via a telecommunication line such as a LAN or the Internet.

The storage unit 42 is a storage device such as an HDD or an SSD. Note that the storage unit 42 may be a semiconductor memory that can rewrite data, such as RAM, a flash memory, or NVSRAM. The storage unit 42 stores an OS and various programs to be executed by the confirmation device 40. Further, the storage unit 42 stores various types of information used in executing the programs. The storage unit 42 stores a general-purpose parameter table 421 having the same configuration as the general-purpose parameter table 321, the system data 322, the first parameter table 324 (e.g., the first parameter table T1), post-application configuration data 425 (e.g., configuration data C2) applied to the migration destination NW device 20, and a second parameter table 426 (e.g., a second parameter table T2) created by an extraction unit 433 (described later).

The control unit 43 controls the entire confirmation device 40. The control unit 43 is, for example, an electronic circuit such as a CPU or MPU, or an integrated circuit such as an ASIC or FPGA. Further, the control unit 43 includes an internal memory for storing a program or control data that defines various processing procedures, and executes each processing using an internal memory. Further, the control unit 43 functions as various processing units by operating various programs. The control unit 43 includes, for example a confirmation unit 431.

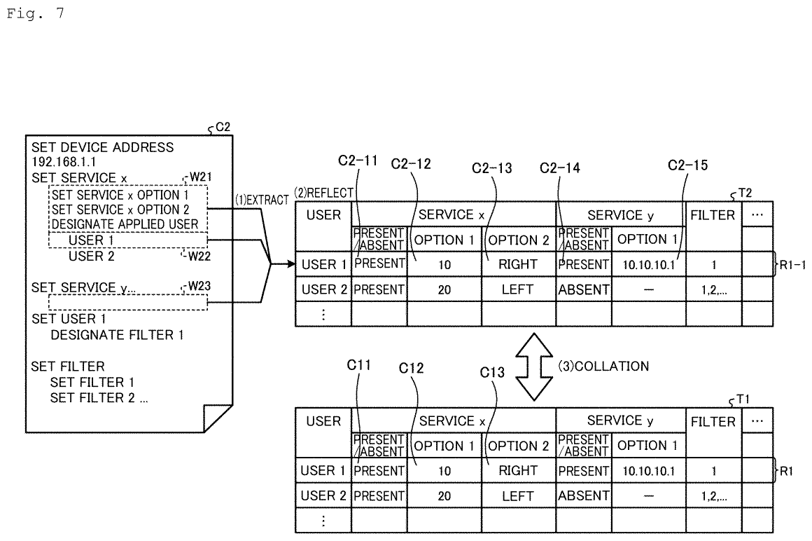

The confirmation unit 431 inputs the configuration data C2 applied to the migration destination NW device 20 and the first parameter table T1. The confirmation unit 431 collates a parameter of the configuration data C2 with a parameter of the first parameter table T1, and confirms that the configuration data C1 is successfully migrated to the migration destination NW device 20. The confirmation unit 431 includes a parameter table creation unit 432, the extraction unit 433 (second extraction unit), a collation unit 434, and a determination unit 435. FIG. 7 is a diagram for explaining processing of the confirmation unit 431 shown in FIG. 6.

The parameter table creation unit 432 has the same function as the parameter table creation unit 332, and creates a general-purpose parameter table T′ (not shown) having the same configuration as the general-purpose parameter table T.

The extraction unit 433 extracts each parameter from the configuration data C2, describes each extracted parameter in a corresponding cell of the general-purpose parameter table T′ created by the parameter table creation unit 432, and creates a second parameter table corresponding to the configuration data C2.

For example, the extraction unit 433 extracts, for the service x of the configuration data C2, the data “service x option setting 1,” “service x option setting 2,” and “user 1” in the areas W21 and W22 ((1) of FIG. 7). The extraction unit 433 then reflects the extracted contents by describing them in cells C2-11, C2-12, and C2-13 corresponding to the service x and its options 1 and 2 in a row R1-1 of the second parameter table T2 ((2) of FIG. 7). Similarly, the extraction unit 433 extracts a parameter related to the service y of an area W23 of the configuration data C2, and reflects the extracted parameter from cells C2-14, C2-15 corresponding to an item of the service y in the row R1-1 of the second parameter table T2.

In this manner, the extraction unit 433 creates the second parameter table T2 in which the parameters of the configuration data C2 are reflected, by extracting each parameter from the configuration data C2 and describing each parameter in a corresponding cell of the general-purpose parameter table T′.

The collation unit 434 collates the second parameter table T2 with the first parameter table T1. The second parameter table T2 and the first parameter table T1 have the same configuration. Therefore, the collation unit 434 collates the second parameter table T2 with the first parameter table T1 by comparing the descriptions of the cells in the same position. For example, in the example of FIG. 7, the collation unit 434 collates the contents described in the cell C2-11 of the second parameter table T2 with the contents described in the cell C11 of the first parameter table T1 ((3) of FIG. 7). The collation unit 434 collates the contents described in the cell C2-12 of the second parameter table T2 with the contents described in the cell C12 of the first parameter table T1 ((3) of FIG. 7).

When the second parameter table T2 matches the first parameter table T1, the determination unit 435 determines that the configuration data C1 is successfully migrated to the migration destination NW device 20. In this case, the determination unit 435 notifies a management server (not shown) of the management system 100 of that the migration of the configuration data between the migration source NW device 10 and the migration destination NW device 20 has been performed successfully.

On the other hand, when the second parameter table T2 does not match the first parameter table T1, the determination unit 435 determines that the configuration data C1 is not successfully migrated to the migration destination NW device 20. In this case, the determination unit 435 notifies the management server of the management system 100 of the unmatched parameter information and of that the migration of the configuration data between the migration source NW device 10 and the migration destination NW device 20 has not been performed successfully.

### Management Processing

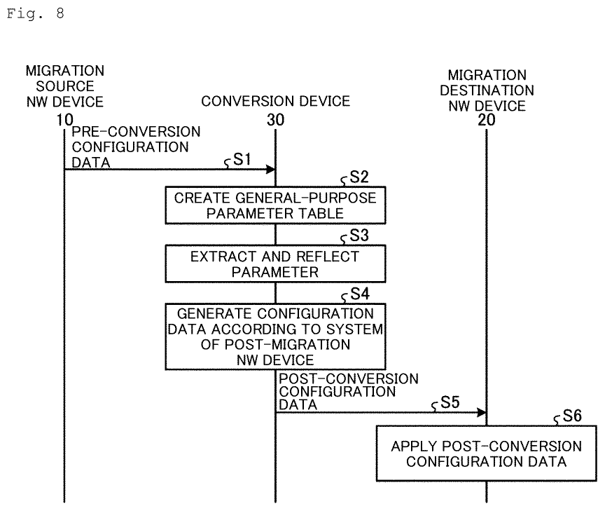

Next, management processing which is executed by the management system 100 will be described. FIG. 8 is a sequence diagram showing an example of a processing procedure of the management processing according to an embodiment.

As shown in FIG. 8, when the configuration is migrated from the migration source NW device 10 to the migration destination NW device 20, first, the conversion device 30 receives the configuration data C1 before conversion from the migration source NW device 10 (step S1). The conversion device 30 creates the general-purpose parameter table T (step S2).

The conversion device 30 extracts each parameter from the configuration data C1, and describes and reflects each extracted parameter in a corresponding cell of the general-purpose parameter table T (step S3), thereby creating the first parameter table T1 corresponding to the configuration data C1.

The conversion device 30 arranges the parameters described in the respective cells of the first parameter table T1 according to the system of configuration data applied to the migration destination NW device 20, thereby generating the configuration data Ct according to the system of the migration destination NW device 20 (step S4). Then, the conversion device 30 transmits the configuration data Ct (post-conversion configuration data) to the migration destination NW device 20 (step S5), and causes the migration destination NW device 20 to apply the configuration data Ct (step S6).

### Confirmation Processing

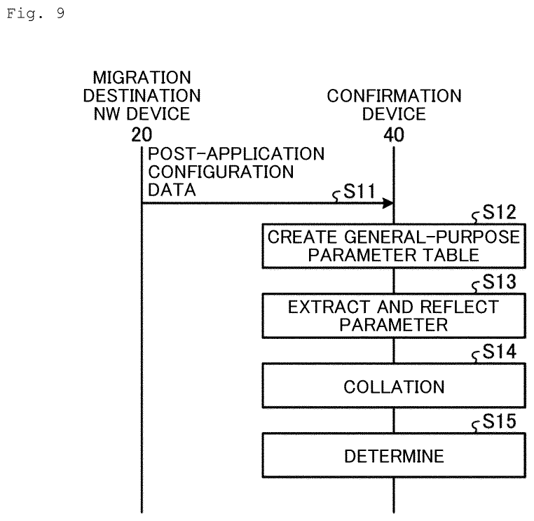

Next, confirmation processing executed by the management system 100 will be described. FIG. 9 is a sequence diagram showing an example of a processing procedure of the confirmation processing according to an embodiment.

As shown in FIG. 9, the confirmation device 40 receives the configuration data C2 applied to the migration destination NW device 20, from the migration destination NW device 20 (step S11). Note that the confirmation device 40 has already acquired the first parameter table T1 created by the conversion device 30.

The confirmation device 40 creates the general-purpose parameter table T′ having the same configuration as the general-purpose parameter table T (step S12). The confirmation device 40 extracts each parameter from the configuration data C2, and describes and reflects each extracted parameter in a corresponding cell of the general-purpose parameter table T′ created in step S11 (step S13), thereby creating the second parameter table T2 corresponding to the configuration data C2.

The confirmation device 40 collates the second parameter table T2 with the first parameter table T1 (step S14). The confirmation device 40 determines whether or not the migration of the configuration data C1 to the migration destination NW device 20 is successfully performed, on the basis of the collation result of step S14 (step S15).

### Advantageous Effects of Embodiments

Thus, in the embodiments, the system of the configuration data C1 for setting the operation of the migration source NW device 10 is converted into the configuration data Ct according to the system of the configuration data of the migration destination NW device 20 by using a general-purpose parameter table capable of associating each service in a user unit.

Specifically, in the embodiments, each parameter is extracted from the configuration data C1, and each extracted parameter is described in a corresponding cell of the general-purpose parameter table T, whereby the first parameter table T1 corresponding to the configuration data C1 is created. In the embodiments, the configuration data Ct, in which parameters described in each cell of the first parameter table T1 are arranged according to the system of the configuration data applied to the migration destination NW device 20, is generated. Thus, in the embodiments, the configuration data can be migrated between network devices of mutually different configuration systems.)

In particular, in migration from the current NW device to the successor NW device in a communication carrier network, it is necessary to suppress the influence of user communication. For this reason, the setting information of the current NW device must be successfully taken over by the successor NW device configuration after the conversion. However, when the configuration systems are different, it was not possible to confirm whether or not the setting information was taken over, by simply comparing the absence of the differences.

On the other hand, in the present embodiments, whether the migration of the configuration data C1 to the migration destination NW device 20 is successfully performed or not is confirmed on the basis of the configuration data C2 applied to the migration destination NW device 20 and the first parameter table T1.

Specifically, in the embodiments, each parameter is extracted from configuration data C2, and each extracted parameter is described in a corresponding cell of the general-purpose parameter table T′ having the same configuration as the general-purpose parameter table, whereby the second parameter table T2 corresponding to the configuration data C2 is created. In the embodiments, by collating the second parameter table T2 with the first parameter table T1, whether the configuration data C1 is successfully migrated to the migration destination NW device 20 or not is confirmed by confirming whether the migration of the configuration data C1 to the migration destination NW device 20 is successfully performed or not.

Thus, according to the embodiments, even if the configuration systems are different, it is possible to appropriately confirm whether or not the configuration data C1 is successfully migrated to the migration destination NW device 20.

As described above, according to the embodiments, even if the configuration system differs between the migration source NW device 10 and the migration destination NW device 20, configuration conversion and normality confirmation can be appropriately executed.

### Modifications of Embodiments

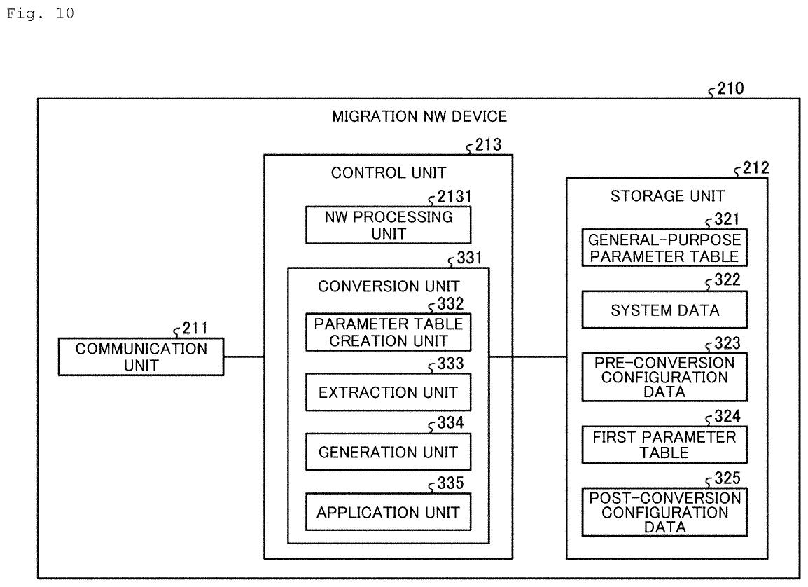

The migration source NW device may have the function of the conversion device 30. FIG. 10 is a block diagram showing an example of a configuration of a migration source NW device. As shown in FIG. 10, a migration source NW device 210 may have a configuration including the conversion unit 331. In this case, the migration source NW device 210 executes the processing executed by the conversion device 30. Note that a communication unit 211 has functions similar to those of the communication unit 11 shown in FIG. 2, and a storage unit 212 has functions similar to those of the storage unit 12 shown in FIG. 2. A control unit 213 has functions similar to those of the control unit 13 shown in FIG. 2, and includes an NW processing unit 2131 for executing various kinds of processing between NW devices, and the conversion unit 331.

### System Configuration of Embodiments

The components of the conversion device 30, the confirmation device 40, and the migration source NW device 210 are functional concepts and do not necessarily have to be physically configured as shown in the drawings. In other words, specific forms of distribution and integration of functions of the conversion device 30, the confirmation device 40, and the migration source NW device 210 are not limited to those illustrated in the drawings, and all of or a part of the functions can be functionally or physically distributed or integrated in arbitrary units according to various types of loads, usage conditions, and the like.

Some or all of the steps of the processing performed in the conversion device 30, the confirmation device 40, and the migration source NW device 210 may be implemented by a CPU, a GPU (Graphics Processing Unit), or a program analyzed and executed by the CPU or the GPU. Each step of processing performed in the conversion device 30, the confirmation device 40, and the migration source NW device 210 may be implemented as hardware in accordance with a wired logic.

In addition, all of or a part of the steps of processing described in the embodiments as being automatically performed can be manually performed instead. Alternatively, all of or a part of the steps of processing described as being manually performed can be performed automatically according to a known method. Furthermore, processing procedures, control procedures, specific names, and information including various types of data and parameters described above and illustrated in the drawings can be appropriately changed unless otherwise specified.

### Program

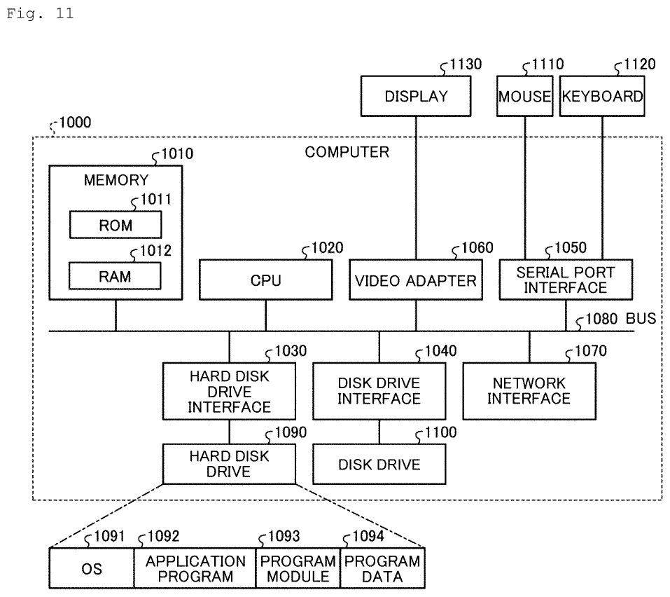

FIG. 11 is a diagram showing an example of a computer with which the conversion device 30, the confirmation device 40, and the migration source NW device 210 are realized through execution of a program. A computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. These units are connected to one another via a bus 1080.

The memory 1010 includes a ROM 1011 and a RAM 1012. The ROM 1011 stores, for example, a boot program, such as a BIOS (Basic Input Output System). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS (Operating System) 1091, an application program 1092, a program module 1093, and program data 1094. That is, a program that defines each step of processing performed by the conversion device 30, the confirmation device 40, and the migration source NW device 210 is implemented as the program module 1093 in which codes that can be executed by the computer 1000 are written. The program module 1093 is stored in, for example, the hard disk drive 1090. For example, the program module 1093 for executing processing similar to that of the functional configurations of the conversion device 30, the confirmation device 40, and the migration source NW device 210 is stored in the hard disk drive 1090. Note that the hard disk drive 1090 may be replaced with an SSD (Solid State Drive).

Furthermore, setting data used in the processing of the embodiments described above is stored in, for example, the memory 1010 or the hard disk drive 1090 as the program data 1094. In addition, the CPU 1020 reads the program module 1093 and the program data 1094 stored in the memory 1010 or the hard disk drive 1090 onto the RAM 1012 and executes them as necessary.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (LAN (Local Area Network), WAN (Wide Area Network), or the like). Then, the program module 1093 and the program data 1094 may be read by the CPU 1020 from another computer via the network interface 1070.

Although embodiments to which the invention made by the present inventor is applied have been described above, the present invention is not limited by the description and the drawings that constitute a part of the disclosure of the present invention according to the present embodiments. That is, other embodiments, examples, operational techniques, and the like devised by those skilled in the art or the like on the basis of the present embodiments are all included in the scope of the present invention.

### REFERENCE SIGNS LIST

10 Migration source NW device
20 Migration destination NW device
30 Conversion device
31, 41, 211 Communication unit
32, 42, 212 Storage unit
33, 43, 213 Control unit
40 Confirmation device
100 Management system
331 Conversion unit
332, 432 Parameter table creation unit
333, 433 Extraction unit
334 Generation unit
335 Application unit
431 Confirmation unit
434 Collation unit
435 Determination unit
2131 NW processing unit

1. A management system configured to manage a migration from a migration source network device to a migration destination network device among network devices communicating with another communication device on a network, the management system comprising:
a conversion unit, comprising one or more processors, configured to convert a system of first setting data for setting an operation of the migration source network device into second setting data according to a system of setting data of the migration destination network device by using a general-purpose parameter table capable of associating each service in a user unit, and apply the second setting data to the migration destination network device.

2. The management system according to claim 1, wherein the conversion unit includes:
a first extraction unit configured to extract each parameter from the first setting data and describe each extracted parameter in a corresponding cell of the general-purpose parameter table, to create a first parameter table corresponding to the first setting data;
a generation unit configured to generate the second setting data in which a parameter described in each cell of the first parameter table is arranged according to a system of setting data applied to the migration destination network device; and
an application unit configured to apply the second setting data to the migration destination network device.

3. The management system according to claim 2, further comprising:
a confirmation unit configured to confirm whether the first setting data is successfully migrated to the migration destination network device, on the basis of third setting data applied to the migration destination network device and the first parameter table.

4. The management system according to claim 3, wherein the confirmation unit includes:
a second extraction unit configured to extract each parameter from the third setting data and describe each extracted parameter in a corresponding cell of a parameter table having the same configuration as the general-purpose parameter table, to create a second parameter table corresponding to the third setting data;
a collation unit configured to collate the second parameter table with the first parameter table; and
a determination unit configured to determine that a migration of the first setting data to the migration destination network device is successfully performed when the second parameter table matches the first parameter table, and determine that the migration of the first setting data to the migration destination network device is not successfully performed when the second parameter table does not match the first parameter table.

5. A management method executed by a management system configured to manage a migration from a migration source network device to a migration destination network device among network devices communicating with another communication device on a network,
the management system including a conversion device, and
the management method comprising:
converting a system of first setting data for setting an operation of the migration source network device into second setting data according to a system of setting data of the migration destination network device by using a general-purpose parameter table capable of associating each service in a user unit; and
applying the second setting data to the migration destination network device.

6. A non-transitory computer readable medium storing a program, wherein execution of the program causes a computer to execute operations comprising:
converting first setting data for setting an operation of a migration source network device into second setting data according to a system of setting data of a migration destination network device by using a general-purpose parameter table capable of associating each service in a user unit; and
applying the second setting data to the migration destination network device.
